(19) United States
(12) Patent Application Publication
(10) Pub. No.: US 2026/0346981 A1
(43) Pub. Date: Nov. 5, 2026

(54) BRAKING SYSTEM FOR AN AIRCRAFT, THE SYSTEM BEING ACTUATED BY A CONTROL DEVICE AND COMPRISING AN ELECTRICALLY ACTUATED DEVICE

(71) Applicant: SAFRAN LANDING SYSTEMS, Velizy-Villacoublay (FR)

(72) Inventors: David Frank, Moissy-Cramayel (FR); Jérôme Fraval, Moissy-Cramayel (FR); Steve Coustenoble, Moissy-Cramayel (FR)

(73) Assignee: SAFRAN LANDING SYSTEMS, Velizy-Villacoublay (FR)

(21) Appl. No.: 19/739,612

(22) Filed: Jul. 13, 2026

Related U.S. Application Data
(63) Continuation of application No. PCT/FR2025/050031, filed on Jan. 13, 2025.

(30) Foreign Application Priority Data
Jan. 15, 2024 (FR) 24/00350

(51) Int. Cl. B64C 25/44

(52) U.S. Cl. CPC B64C 25/44

(57) ABSTRACT

A braking system for an aircraft includes an electrically actuated device having a bi-stable operating mode and a progressive operating mode. The braking system includes at least one control device capable of generating a park command, which activates the bi-stable operating mode of the electrically actuated device, and a progressive braking command. The braking system includes at least one inhibition system to inhibit an operation of the electrically actuated device according to at least one operating state of a normal braking system, and the at least one progressive braking command is configured to activate the progressive operating mode of the electrically actuated device according to the at least one inhibition system.

### CROSS-REFERENCE TO RELATED APPLICATIONS

This application is a continuation of International Application No. PCT/FR2025/050031, filed on Jan. 13, 2025, which claims priority to and the benefit of French Patent Application No. FR 24/00350 filed on Jan. 15, 2024. The disclosures of the above applications are incorporated herein by reference.

### FIELD

The present disclosure relates to the field of aircraft and more particularly to a braking system and an aircraft provided with such a braking system.

### BACKGROUND

The statements in this section merely provide background information related to the present disclosure and may not constitute prior art.

An aircraft braking system includes a normal braking system, an emergency braking system to supplement the normal braking system in the event of an issue, and a parking braking system making it possible to keep the aircraft stationary.

The emergency braking system allows for a brake pressure level that is variable according to a command from a pilot or a flight control computer.

The parking braking system makes it possible to maintain the brake pressure level when the aircraft is stationary and during aircraft shutdown.

A hydromechanical solution exists that provides a set of members forming part of both the emergency braking system and the parking braking system. This solution has drawbacks such as: difficulty of installation, a cable has to extend from the aircraft cockpit to a main landing gear bay, the inability to monitor potential issues during operation of the aircraft (jamming or breakage of a cable element), performance of regular maintenance operations (monitoring, lubrication of the cable sheath, etc.), the significant weight of the cable system and its fasteners. There is also an electrically actuated solution described in document FR3082503 in which the emergency braking system is at least partially combined with the parking braking system. In this solution, a valve provides both progressive emergency braking and on/off parking braking. The valve is controlled by an action on a control lever equipped with a device capable of delivering a voltage proportional to its position. Pulse width modulation (PWM) control makes it possible to transform this valve into a proportional valve.

### SUMMARY

This section provides a general summary of the disclosure and is not a comprehensive disclosure of its full scope or all of its features.

An electrically actuated braking system that offers easy maintenance, simple installation, low cost, and robustness in the face of driver behavior, and capable of adapting to all types of aircraft is desired.

One form relates to a braking system for an aircraft comprising: at least one electrically actuated device configured to fill at least one cavity of at least one brake of the aircraft with a hydraulic fluid, the electrically actuated device having, on the one hand, a bistable operating mode in which the hydraulic fluid of the at least one cavity of the brake is maintained at a return pressure or at a supply pressure, and on the other hand, a progressive operating mode in which the pressure of the hydraulic fluid of the at least one cavity of the brake is between the return pressure and the supply pressure, and at least one control device capable of generating, on the one hand, at least one parking command that activates the bistable operating mode of the electrically actuated device, and on the other hand, at least one progressive braking command, characterized in that the braking system comprises at least one inhibition system configured to inhibit operation of the at least one electrically actuated device according to at least one operating state of a normal braking system, the at least one progressive braking command being configured to activate the progressive operating mode of the electrically actuated device based on the at least one inhibition system.

The electrically actuated device makes it possible to fill the at least one cavity of the aircraft brake with a hydraulic fluid so as to vary a pressure of the hydraulic fluid at the brakes between a return pressure corresponding to no braking, and a supply pressure corresponding to maximum braking.

The electrically actuated device may comprise a valve in which a spool of the valve connects an outlet port leading to the at least one cavity of the brake to: a return port making it possible to decrease the pressure of the hydraulic fluid, the spool is then defined as being in a passive state, or a supply port making it possible to increase the pressure of the hydraulic fluid, the spool is then defined as being in an active state.

The electrically actuated device may further comprise an electric actuator, such as an electric coil or an electric motor, making it possible to modify the state of the spool.

The electrically actuated device may also comprise a return spring making it possible to return the spool to the passive state when the electric actuator is no longer powered.

The electrically actuated device can operate, depending on the received command, in two modes: the bistable operating mode, that is to say on/off. In this operating mode, the electrically actuated device makes it possible to bring the pressure of the hydraulic fluid at the brake to either the return pressure or the supply pressure. The bistable operating mode is activated by a parking command issued by the control device;

The progressive operating mode, in which the pressure of the hydraulic fluid at the brake is between the return pressure and the supply pressure, the pressure of the hydraulic fluid at the brake depending on the movement applied by a pilot to the progressive braking control member. The progressive operating mode can be activated by a progressive braking command.

The progressive operating mode can be obtained by a PWM control.

For example, the electrically actuated device can be of the type described in document FR3 082 503.

Each of the at least one parking command and the progressive braking command has a return value making it possible to bring the pressure of the hydraulic fluid at the brake to the return pressure and a supply value making it possible to bring the pressure of the hydraulic fluid at the brake to the supply pressure. The progressive braking command can also take at least one value between the return value and the supply value.

The parking command activates the bistable operating mode thereby bringing the hydraulic fluid to either the supply pressure or the return pressure.

The progressive braking command preferably activates a normal braking system, and in the event of an issue with the latter, the progressive braking command activates an emergency braking system comprising the at least one electrically actuated device.

According to the present disclosure, the control device, and therefore the same progressive braking command, makes it possible to activate in a differentiated manner the normal braking system or the emergency braking system.

The emergency braking system comprises elements, such as the electrically actuated device, that are common to the parking braking system.

According to the present disclosure, the progressive braking command is transmitted simultaneously, on the one hand, to the normal braking system, and on the other hand, to the emergency braking system. In order to determine whether the progressive braking command must activate the normal braking system or the emergency braking system, the present disclosure comprises an inhibition system.

The inhibition system is configured to inhibit, that is to say inhibit operation of the electrically actuated device according to at least one operating state of the normal braking system. In other words, the inhibition system enables or inhibits operation of the emergency braking system by a progressive braking command.

The operating state of the normal braking system corresponds to the ability of the normal braking system to provide a braking level requested by the progressive braking command.

When the requested braking level can be achieved by the normal braking system, the normal braking system is said to be operational. The inhibition system then blocks activation of the emergency braking system by the progressive braking command, so that the progressive braking command activates the normal braking system. The electrically actuated device is therefore not activated.

When the requested braking level cannot be adequately achieved by the normal braking system, the normal braking system is said to be faulty. The inhibition system no longer blocks the operation of the electrically actuated device, and braking is performed by the emergency braking system. The progressive braking command, sent to the electrically actuated device, activates the progressive operating mode, thereby bringing the hydraulic fluid to a variable value between the supply pressure and the return pressure.

The braking system according to the present disclosure provides an electrically actuated solution that makes it possible to share a set of members forming part of both the emergency braking system and the parking braking system. The braking system is therefore simple, inexpensive, and allows for improved piloting comfort.

The present disclosure may also have one or more of the following features, taken alone or in combination.

In some forms, the at least one control device is a computer.

For example, the computer is a flight control computer or a braking system control computer.

Preferably, and for reasons of availability, redundancy of the control device is provided. The braking system according to the present disclosure then comprises at least two control devices.

Preferably, a distinction is made between the active control device and the passive control device.

Thus, the braking system according to the present disclosure can be used in an unmanned aircraft, or in an aircraft in which normal, emergency, and parking braking commands are transmitted from the control device.

In some forms, the at least one parking command has a value within a first range of a control signal, and the at least one progressive braking command has a value within a second range of the control signal.

The first range and the second range of the control signal each comprise a return value and a supply value.

In some forms, the return value of the first range and the second range of the control signal coincide.

For example, the first range of the control signal may extend from [−10% to 0%], while the second range of the control signal may extend from [0% to 100%].

In some forms, the at least one inhibition system receives at least one inhibition command.

For example, the inhibition command is issued by at least one computer of the normal braking system, or by an aircraft computer, or by a flight control computer.

The normal braking system comprises, for example, at least one computer that determines the operating state of the normal braking system.

In some forms, the at least one inhibition command is issued when the normal braking system is operational.

In some forms, no inhibition command is issued when the normal braking system has an issue.

Thus, in the event of loss of the normal braking system, when no further inhibition commands are issued, the electrically actuated device will be activated by a progressive braking command.

In some forms, the normal braking system comprises two redundant computers. Thus, each of the computers issues at least one inhibition command.

The emergency braking system is inhibited when it receives an inhibition command from each of the computers, or at least one inhibition command from one of the two computers.

In some forms, the at least one inhibition system comprises at least one isolation device having an open state and a closed state, the at least one isolation device being configured to isolate an electrical or hydraulic supply of the electrically actuated device according to the at least one inhibition command.

Depending on the inhibition command received by the inhibition system, the isolation device changes state so as to electrically or hydraulically supply or isolate the electrically actuated device.

In some forms, the at least one inhibition system comprises at least one logic gate receiving the at least one inhibition command.

A logic gate is an electronic circuit that carries out at least one logic operation, that is to say, a Boolean operation.

For example, the inhibition system may comprise at least one NOR gate, that is to say NOT OR gate, or an AND gate, or an OR gate.

In some forms, the at least one inhibition system comprises at least one electromechanical relay, or a coil of a hydraulic isolation valve, or an electromagnetic coil receiving the at least one inhibition command.

An electromechanical relay, also called an electronic relay or electrical switch, made using an electronic transistor, is an electric member that allows an electrical signal to be passed or interrupted according to a received command, in this case the inhibition command.

The coil of a hydraulic isolation valve, or an electromagnetic coil, allows an isolation valve to be opened or closed by moving a spool or a poppet.

In some forms, the at least one control device generates at least one first progressive braking command and at least one second progressive braking command, the progressive braking command being determined according to the first and second progressive braking commands.

The control device generates, on the one hand, a first progressive braking command and, on the other hand, a second progressive braking command. This makes it possible to determine various components of the progressive braking command, and more specifically, a first component and a second component of the progressive braking command. In other words, the components of the progressive braking command are the various input data whose combination makes it possible to obtain the progressive braking command.

For example, the first component of the progressive braking command is a right progressive braking command, while the second component of the progressive braking command is a left progressive braking command.

The progressive braking command can therefore comprise two components so as to achieve differential braking between a right brake and a left brake of the aircraft, or alternatively, the progressive braking command is determined based on the right progressive braking component and the left progressive braking component so as to determine a more precise and/or safer braking command through redundancy.

Finally, the control device can issue: a right progressive braking command, a left progressive braking command,

The progressive braking command is determined based on each of the progressive braking commands above, for example: the progressive braking command is equal to the maximum among the braking commands listed above; the progressive braking command is equal to the average or sum of the braking commands listed above;

In some forms, the at least one control device determines a normal progressive braking command configured to operate the normal braking system and an emergency progressive braking command configured to operate the at least one electrically actuated device.

The normal progressive braking command makes it possible to operate the normal braking system, while the emergency progressive braking command makes it possible to operate the emergency braking system.

Another aspect of the present disclosure relates to an aircraft provided with a braking system according to the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic representation of a braking system according to a first form of the present disclosure;

FIG. 2 is a schematic representation of an inhibition system according to a first form;

FIG. 3 is a schematic representation of an inhibition system according to a second form;

FIG. 4 is a schematic representation of a braking system according to a second form of the present disclosure; and

FIG. 5 is a schematic representation of a braking system according to a third form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Only the elements necessary for understanding the present disclosure have been represented. To facilitate reading the drawings, the same elements are designated by the same reference numerals from one figure to another.

The present disclosure relates to a braking system 1, 1′, 1″ for an aircraft.

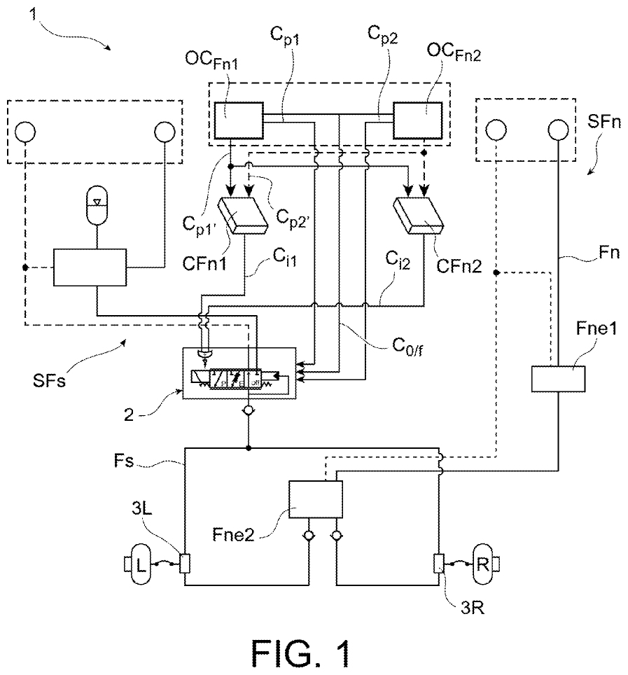

In a first form illustrated in FIG. 1, the aircraft comprises a group of right wheels and a group of left wheels L, R, each being connected to brake cavities 3R, 3L.

During braking, the cavities 3L, 3R are filled with a hydraulic fluid Fn, Fs.

When a pressure of the hydraulic fluid Fn, Fs at the cavities 3L, 3R of the brakes is equal to a return pressure, no braking occurs, in other words 0% braking.

When a pressure of the hydraulic fluid Fn, Fs at the cavities 3L, 3R of the brakes is equal to a supply pressure, braking at a maximum level occurs, in other words 100% braking.

When a pressure of the hydraulic fluid Fn, Fs at the cavities 3L, 3R of the brakes is between the supply pressure and the return pressure, braking at a variable level occurs, in other words braking that varies between 0% and 100%.

The braking system 1 comprises a normal braking system designed to provide braking at a variable level, that is to say between 0% and 100%. To this end, the normal braking system comprises a control portion that operates a normal hydraulic portion SFn, the normal hydraulic portion SFn comprising a plurality of elements Fne1, Fne2 making it possible to vary the pressure of the hydraulic fluid Fn at the cavities 3L, 3R of the brakes between 0% and 100%.

There are many ways to implement the normal braking system, the described elements are just one example.

The braking system 1 also comprises emergency and parking braking systems designed to provide, on the one hand, emergency braking at a variable level, and on the other hand, parking braking at the supply pressure.

To this end, the emergency and parking braking systems comprise, in particular, an emergency hydraulic portion SFs that is provided in particular with an electrically actuated device 2.

The electrically actuated device 2 may comprise a valve in which a spool of the valve connects an outlet port of the emergency hydraulic portion SFs leading to the at least one cavity 3L, 3R of the brake to: a return port of the emergency hydraulic portion SFs, making it possible to decrease the pressure of the hydraulic fluid Fs, the spool is then defined as being in a passive state, or a supply port of the emergency hydraulic portion SFs, making it possible to increase the pressure of the hydraulic fluid Fs, the spool is then defined as being in an active state.

The electrically actuated device 2 may further comprise an electric actuator, such as an electric coil or an electric motor, making it possible to modify the state of the spool.

The electrically actuated device 2 may also comprise a return spring making it possible to return the spool to the passive state when the electric actuator is no longer powered.

The electrically actuated device 2 can operate in two modes: a bistable operating mode, that is to say on/off. In this operating mode, the electrically actuated device 2 makes it possible to bring the pressure of the hydraulic fluid Fs at the cavity 3R, 3L of the brake to either the return pressure or the supply pressure. The bistable operating mode is activated by a parking command Co/f issued by at least one control device OC_{Fn1}, OC_{Fn2}; a progressive operating mode in which the pressure of the hydraulic fluid Fs at the cavity 3R, 3L of the brake is between the return pressure and the supply pressure. The progressive operating mode can be activated, under certain conditions, by a progressive braking command Cₚ₁, Cₚ₂ issued by the at least one control device OC_{Fn1}, OC_{Fn2}.

The progressive operating mode can be obtained by a PWM control.

For example, the electrically actuated device 2 can be of the type described in document FR3 082 503.

Each of the at least one parking command Co/f and the progressive braking command Cₚ₁, Cₚ₂, C_{p1′}, C_{p2′} has a return value making it possible to bring the pressure of the hydraulic fluid at the brake to the return pressure and a supply value making it possible to bring the pressure of the hydraulic fluid at the brake to the supply pressure. The progressive braking command Cₚ₁, Cₚ₂, C_{p1′}, C_{p2′} can also take at least one value between the return value and the supply value.

The braking system according to the first form of the present disclosure comprises a primary control device OC_{Fn1}, and a redundant control device OC_{Fn2}.

Each control device is a computer, for example, a flight computer.

Each control device generates a parking command C_{o/f} making it possible to activate the bistable operating mode of the electrically actuated device 2, thereby bringing the hydraulic fluid Fs to either the supply pressure or the return pressure.

The control devices OC_{Fn1}, OC_{Fn2} also each generate a normal progressive braking command C_{p1′}, C_{p2′}, configured to operate the normal braking system of the aircraft and an emergency progressive braking command Cₚ₁, Cₚ₂ configured to operate the emergency braking system of the aircraft.

Thus, the primary control device OC_{Fn1} generates a primary normal progressive braking command C_{p1′} and a primary emergency progressive braking command Cₚ₁, while the redundant control device OC_{Fn2} generates a redundant normal progressive braking command C_{p2′} and a redundant emergency progressive braking command Cₚ₂. In some forms, the primary normal progressive braking command C_{p1′} and a primary emergency progressive braking command Cₚ₁ are combined, and the redundant normal progressive braking command C_{p2′} and a redundant emergency progressive braking command Cₚ₂ are combined.

The primary normal progressive braking command C_{p1′} and the redundant normal progressive braking command C_{p2′} are each transmitted to the normal braking system, and specifically to a primary computer CFn1 and a redundant computer CFn2.

The primary computer CFn1 and the redundant computer CFn2 operate the normal braking system so as to vary the pressure of the hydraulic fluid Fn between 0% and 100%.

The primary computer CFn1 and the redundant computer CFn2 also determine an operating state of the normal braking system, that is to say the ability of the normal braking system to provide a braking level requested by the primary C_{p1′} and redundant C_{p2′} normal progressive braking command. When the requested braking level can be achieved by the normal braking system, the normal braking system is said to be operational; whereas, when this is not the case, the normal braking system is said to be faulty.

Thus, according to the operating state of the normal braking system, and more particularly when the normal braking system is operational, the primary computer CFn1 and the redundant computer CFn2 issue, to an inhibition system, respectively a primary inhibition command Cᵢ₁ and a redundant inhibition command Cᵢ₂. Thus, no inhibition command is issued when the normal braking system is faulty, such as if the two computers CFn1, CFn2 are faulty.

The inhibition system can be implemented according to various forms.

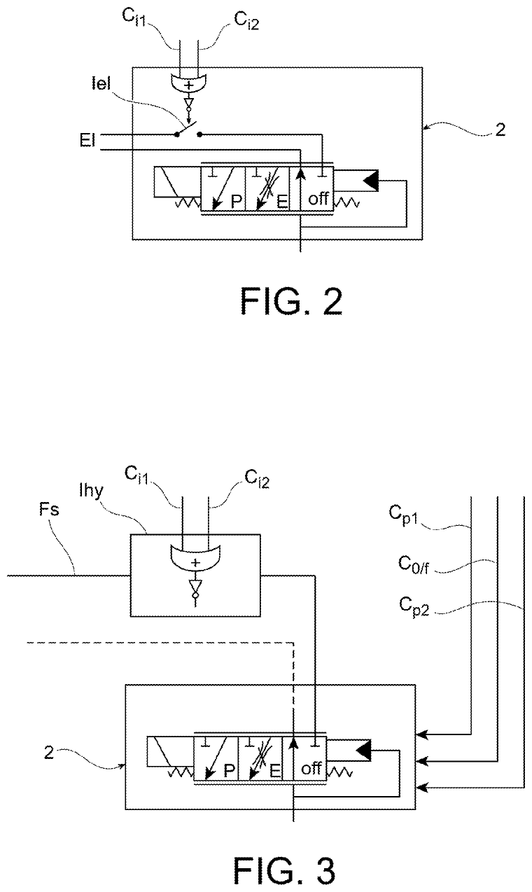

A first form is illustrated in FIG. 2. In this form, the inhibition system comprises an electrical isolation device lel having an open state and a closed state, which is configured to isolate an electrical supply El of the electrically actuated device 2 according to the primary inhibition command Cᵢ₁ and the redundant inhibition command Cᵢ₂.

The primary inhibition command Cᵢ₁ and the redundant inhibition command Cᵢ₂ are input signals of a NOR logic gate. Thus, when the logic gate receives at least one of the primary inhibition command Cᵢ₁ and the redundant inhibition command Cᵢ₂, that is to say, when at least one of the computers detects that the normal braking system is operational, the electrical isolation device lel is in the open state and the electrically actuated device 2 cannot operate. When the logic gate receives neither the primary inhibition command Cᵢ₁ nor the redundant inhibition command Cᵢ₂, that is to say, when the two computers detect an issue with the normal braking system, the electrical isolation device lel is in the closed state and the electrically actuated device 2 can operate, that is to say, the electrically actuated device 2 will be activated according to the redundant emergency progressive braking command Cₚ₂ and the primary emergency progressive braking command Cₚ₁.

A second form is illustrated in FIG. 3. In this form, the inhibition system comprises a hydraulic isolation device Ihy having an open state and a closed state, which is configured to isolate a hydraulic supply Fs of the electrically actuated device 2 according to the primary inhibition command Cᵢ₁ and the redundant inhibition command Cᵢ₂.

The primary inhibition command Cᵢ₁ and the redundant inhibition command Cᵢ₂ are input signals of a NOR logic gate. Thus, when the logic gate receives at least the primary inhibition command Cᵢ₁ or the redundant inhibition command Cᵢ₂, the hydraulic isolation device Ihy is in the open state and the electrically actuated device 2 cannot therefore vary the pressure of the hydraulic fluid in the cavity of the brake. When the logic gate receives neither the primary inhibition command Ci1 nor the redundant inhibition command Cᵢ₂, the hydraulic isolation device Ihy is in the closed state and the electrically actuated device 2 can operate, that is to say, the electrically actuated device 2 will be activated by the redundant emergency progressive braking command Cₚ₂, or by the primary emergency progressive braking command Cₚ₁, thereby bringing the hydraulic fluid to the supply pressure.

Another form of the inhibition system involves replacing the NOR logic gate of the first or second form described above with a first mechanical or electronic relay, also called an electronic switch, and a second mechanical or electronic relay positioned in series. Each mechanical relay is in an open state when it receives the primary inhibition command Cᵢ₁ or the redundant inhibition command Cᵢ₂, and in a closed state otherwise.

In the form of FIG. 1, the primary control device OC_{Fn1} is determined as the active or master control device, and the redundant control device OC_{Fn2} is determined as the passive control device. As long as the primary control device OC_{Fn1} is operational, the electrically actuated device 2 receives only the primary emergency progressive braking command Cₚ₁. When the primary control device OC_{Fn1} is faulty, the electrically actuated device 2 then receives the redundant emergency progressive braking command Cₚ₂.

When the inhibition device does not block the operation of the electrically actuated device 2, the latter will be activated according to the received emergency progressive braking command.

The parking command C_{o/f} has a value within a first range of a control signal, and the at least one progressive braking command Cₚ₁, C_{p1′}, Cₚ₂, C_{p2′} has a value within a second range of the control signal.

The first range and the second range of the control signal each comprise a return value and a supply value.

In some forms, the return values of the first range and the second range of the control signal coincide.

For example, the first range of the control signal may extend from [−10% to 0%], while the second range of the control signal may extend from [0% to 100%].

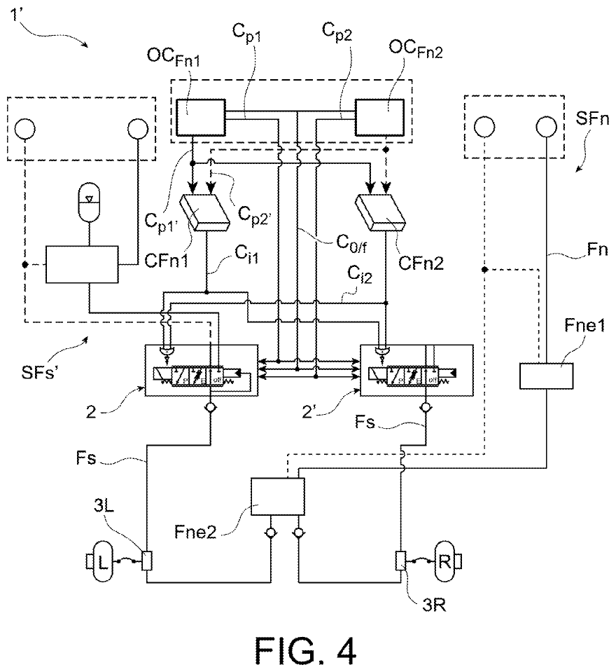

A second form is illustrated in FIG. 4. This form is identical to the first form with respect to the presence of two groups of wheels R, L, the normal hydraulic portion SFn, the primary control device OC_{Fn1} and the redundant control device OC_{Fn2}, the primary computer CFn1, and the redundant computer CFn2.

In the second form, the primary control device OC_{Fn1} and the redundant control device OC_{Fn2} each determine a right progressive braking command and a left progressive braking command. Thus, the control device OC_{Fn1}, OC_{Fn2} according to the second form generates the following commands: the primary normal progressive braking command C_{p1′}, comprising the primary normal right progressive braking command and the primary normal left progressive braking command; The primary emergency progressive braking command Cₚ₁, comprising the primary emergency right progressive braking command and the primary emergency left progressive braking command; The redundant normal progressive braking command C_{p2′}, comprising the redundant normal right progressive braking command and the redundant normal left progressive braking command; The redundant emergency progressive braking command Cₚ₂, comprising the redundant emergency right progressive braking command and the redundant emergency left progressive braking command.

The second form differs from the first form in the emergency hydraulic portion SFs′, which is in particular provided with two electrically actuated devices 2, 2′.

Each electrically actuated device 2, 2′ is identical to that described in the first form.

Each electrically actuated device 2, 2′ comprises a bistable operating mode that is activated by the parking command C_{o/f} issued by the control device, and a progressive operating mode that can be activated, under certain conditions, by the emergency progressive braking command Cₚ₁, Cₚ₂.

Furthermore, operation of each electrically actuated device 2, 2′ is either enabled or inhibited by an inhibition system similar to one of the variants described above.

In the emergency hydraulic portion SFs′ of the second form, a first electrically actuated device 2 supplies only the cavities 3L of the brakes in the group of the left wheels L, while a second electrically actuated device 2′ supplies only the cavities 3R of the brakes in the group of the right wheels R.

The first electrically actuated device 2 modifies a pressure of the hydraulic fluid Fs according to the primary emergency left progressive braking command or the redundant emergency left progressive braking command, while the second electrically actuated device 2 modifies a pressure of the hydraulic fluid Fs according to the primary emergency right progressive braking command or the redundant emergency right progressive braking command.

In this form, differential control of the right brakes and the left brakes is carried out, in particular during braking with the emergency braking system.

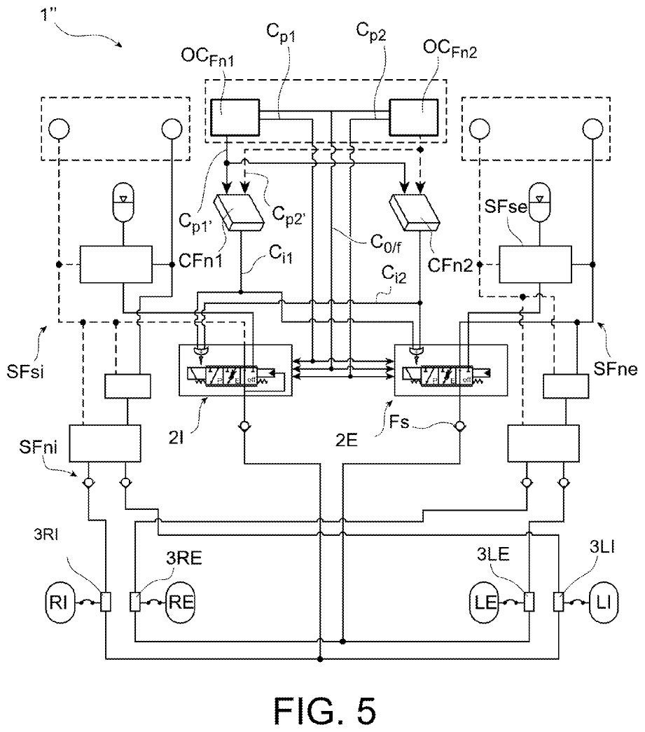

A third form is illustrated in FIG. 5. This form differs from the first and second forms by the presence of a group of right inner wheels and a group of right outer wheels, as well as a group of left inner wheels and a group of left outer wheels, each group of wheels being connected to brake cavities 3RE, 3RI, 3LE, 3LI.

Alternatively, this form may comprise inner front wheels and inner rear wheels, as well as outer front wheels and outer rear wheels, each group of wheels being connected to brake cavities 3RE, 3RI, 3LE, 3LI.

The third form also comprises an inner normal hydraulic portion SFni that supplies the cavities of the inner wheels and an outer normal hydraulic portion SFne that supplies the cavities of the outer wheels, an inner emergency hydraulic portion SFsi that supplies the cavities of the inner wheels, and an outer emergency hydraulic portion SFse that supplies the cavities of the outer wheels. Each emergency hydraulic portion is identical to that of the first form. The third form therefore comprises an outer electrically actuated device 2E and an inner electrically actuated device 2I.

The third form is identical to the second form with respect to the control device OC_{Fn2}, OC_{Fn1}.

The inner electrically actuated device 2I modifies a pressure of the hydraulic fluid according to the inner primary emergency progressive braking command or the inner redundant emergency progressive braking command, while the second electrically actuated device 2E modifies a pressure of the hydraulic fluid according to the outer primary emergency progressive braking command or the outer redundant emergency progressive braking command.

Furthermore, operation of each electrically actuated device 2E, 2I is either enabled or inhibited by an inhibition system that can: be similar to one of the variants described above. In other words, an issue with one of the two computers does not result in braking by the emergency braking system; and operation of the emergency braking system is inhibited only when the two computers issue an inhibition command. In other words, an issue with at least one of the two computers results in braking by the emergency braking system; and inhibits operation of only one of the electrically actuated devices 2I, 2E.

The braking system according to the present disclosure provides an electrically actuated solution that makes it possible to share a set of members forming part of both the emergency braking system and the parking braking system. The present disclosure is therefore simple, inexpensive, and allows for improved piloting comfort.

Although the present disclosure has been described with reference to specific forms, it is evident that modifications and changes can be made to these examples without departing from the general scope of the present disclosure as defined by the claims. In particular, individual features of the various illustrated/mentioned forms can be combined in additional forms. Therefore, the description and drawings should be considered in an illustrative rather than restrictive sense.

It is also evident that all the features described with reference to a method are transposable, alone or in combination, to a device, and conversely, all the features described with reference to a device are transposable, alone or in combination, to a method.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A braking system for an aircraft, comprising:
an electrically actuated device configured to fill at least one cavity of at least one brake of the aircraft with a hydraulic fluid, the electrically actuated device having a bistable operating mode in which the hydraulic fluid of the at least one cavity of the brake is maintained at either a return pressure or a supply pressure, and a progressive operating mode in which a pressure of the hydraulic fluid of the at least one cavity of the brake is between the return pressure and the supply pressure; and
at least one control device configured to generate at least one parking command that activates the bistable operating mode of the electrically actuated device and at least one progressive braking command,
wherein the braking system comprises at least one inhibition system configured to inhibit operation of the at least one electrically actuated device based on at least one operating state of a normal braking system and the at least one progressive braking command is configured to activate the progressive operating mode of the electrically actuated device based on the at least one inhibition system.

2. The braking system according to claim 1, wherein the at least one control device is a computer.

3. The braking system according to claim 1, wherein the at least one parking command has a value within a first range of a control signal, and the at least one progressive braking command has a value within a second range of the control signal.

4. The braking system according to claim 1, wherein the at least one inhibition system is configured to receive at least one inhibition command.

5. The braking system according to claim 4, wherein the at least one inhibition system comprises at least one isolation device having an open state and a closed state, the at least one isolation device is configured to isolate an electrical or hydraulic supply of the electrically actuated device based on the at least one inhibition command.

6. The braking system according to claim 4, wherein the at least one inhibition system comprises at least one logic gate configured to receive the at least one inhibition command.

7. The braking system according to claim 4, wherein the at least one inhibition system comprises at least one electromechanical relay or a coil of a hydraulic isolation valve, or an electromagnetic coil receiving the at least one inhibition command.

8. The braking system according to claim 1, wherein the at least one control device is configured to generate at least one first progressive braking command and at least one second progressive braking command, and the at least one progressive braking command is determined based on the at least one first progressive braking command and the at least one second progressive braking command.

9. The braking system according to claim 1, wherein the at least one control device is configured to determine a normal progressive braking command configured to operate the normal braking system and an emergency progressive braking command configured to operate the at least one electrically actuated device.

10. An aircraft provided with a braking system according to claim 1.
